(19) United States
(12) Patent Application Publication
(10) Pub. No.: US 2005/0068557 A1
(43) Pub. Date: Mar. 31, 2005

(54) System and method for adaptively controlling print options

(75) Inventors: Ronnie Neil Patton, Lake Oswego, OR (US); Burton L. Levin, Lake Oswego, OR (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/673,808

(22) Filed: Sep. 29, 2003

(51) Int. Cl. G06F 15/00

(52) U.S. Cl. 358/1.13; 358/1.15

(57) ABSTRACT

A system and method are provided for adaptively controlling print options in a print system. The method comprises: accepting an imaging job; determining the imaging job characteristics; determining an imaging system's capabilities; matching system capabilities to job characteristics; and, performing the job on an imaging device. Determining job characteristics may involve determining the optimal print media, ink chemistry, or image processing. The imaging job characteristics may be determined by examining the print driver print stream to determine the file type, enacting a user interface dialog with the user, receiving pre-determined imaging job characteristics from a device driver embedded in a PRN image file, or-receiving pre-determined imaging job characteristics from a device driver embedded in a job stream. Determining the system capabilities may include determining the available print media, available inks, available image processes, or imaging device firmware.

### BACKGROUND OF THE INVENTION

1. Field of the Invention

This invention generally relates to digital imaging processing and, more particularly, to a system and method for adaptively controlling imagining device print options.

2. Description of the Related Art

When using imaging devices, such as a printer, scanner, fax, copier, or multifunctional peripheral (MFP), the printing image quality is principally affected by several parameters, such as: image processing, ink chemistry, paper type, and printer hardware characteristics. For a specific printer, the user can only control a few of these parameters. The most important parameters are: choice of paper and choice of image processing. Image processing is many times restricted to choosing processing modes, such as, ‘photo’, ‘best’, ‘normal’, or ‘draft’.

Choosing the paper type requires the user to know what paper is currently loaded in the printer. Furthermore, the user must also be aware of the relationship between the paper media, ink, and the image processing choices available in the printer driver and printer firmware. It is frequently true that the casual user does not have the expertise to make intelligent choices for the best output.

It is very awkward, sometimes impossible, for either an expert or a casual user of a printing system to access information that will permit the user to optimize their printing options. The expert user can benefit from a means that would permit them to obtain information about the total system, allowing them to make intelligent choices among the available print options. The casual user could benefit from an intermediary means that could provide suggestions as to the best choices of options. For example, the intermediary means could be simple questions posed in the driver user interface (UI) using information that is acquired both statically and dynamically from previous interactions with the total printing system. The total printing system options may include, for example, the available print media, the printer capabilities, the firmware finishing and image processing features, and the host printer driver options. Compiling and utilizing this information in driver software, firmware, and hardware is currently impractical, if not impossible.

There are many conventional schemes for encoding printer paper that permit the printer hardware to detect the type and attributes of the paper. However, there are no schemes that use the system capabilities information, such as media, ink, and system image processing to analyze the request, the document, and to suggest the best cost/performance output. Neither do these schemes use the system capabilities information to locate the best available printer on the network.

It would be advantageous if a user could obtain the optimum printing results without necessarily being a systems expert, or without personally examining the capabilities of every imaging device in the system.

### SUMMARY OF THE INVENTION

The present invention uses uniquely encoded print media, together with knowledge of both the printer's and the host driver's image processing capabilities, to direct the expert and casual user in making the best printing choice from the available options. It further describes the interaction between the printer firmware and host driver software that presents the user with informed choices for rendering and printing according to their actual intent. For example, if the user desires photo quality, they are warned against using bond paper.

Furthermore, the present invention system can locate the best printer on the network, based on the software system's knowledge of available printers, where the “best printer” is the one that has the best fit of media, ink, image processing capability, and other features of the possible target printers. The presentation to the user can be made such that the user does not need to have specialized knowledge of image processing or printer capabilities. This capability provides the user with feedback about the eventual quality of the output, allowing the user to make informed choices concerning the type of output quality desired.

Accordingly, a method is provided for adaptively controlling print options in a print system. The method comprises: accepting an imaging job; determining the imaging job characteristics; determining an imaging system's capabilities; matching system capabilities to job characteristics; and, performing the job on an imaging device. Determining job characteristics may involve determining the optimal print media, ink chemistry, or image processing. The imaging job characteristics may be determined by examining the print driver print stream to determine the file type, enacting a user interface dialog with the user, receiving pre-determined imaging job characteristics from a device driver embedded in a PRN image file, or receiving pre-determined imaging job characteristics from a device driver embedded in a job stream.

Determining the system capabilities may include determining the available print media, available inks, available image processes, or imaging device firmware. For example, the available print media may be determined by enacting a user interface dialog with a user from an imaging device front panel, the imaging device reading print media identification of loaded paper, or accessing a memory of stored media data. From one of these actions, print media characteristics such as media type, media weight, media brightness, tray number, and media name (or media identification) can be determined. In another example, the determination of available image processes may involve the determining an imaging device's resolution capabilities.

In some aspects, the method further comprises: automatically selecting the imaging device capabilities in response to matching of system capabilities to job characteristics. If the capabilities fall below minimum quality thresholds, a user can be presented with a user interface dialog for the selection of alternate imaging system capabilities. Alternately, imaging system capabilities can be matched to job characteristics and presented on a user interface. Then, a user interface dialog is supplied for the manual selection of imaging system capabilities.

Additional features of the above-mentioned method, and a imaging device system for adaptively controlling print options, are provided below.

### BRIEF DESCRIPTION OF THE DRAWINGS

FIG. 1 is a schematic block diagram of the present invention imaging device system for adaptively controlling print options.

FIG. 2 is a schematic block diagram of the present invention imaging device system for adaptively controlling print options, with client-side features.

FIG. 3 is a flowchart illustrating the present invention method for adaptively controlling print options in a print system.

### DETAILED DESCRIPTION OF THE PREFERRED EMBODIMENTS

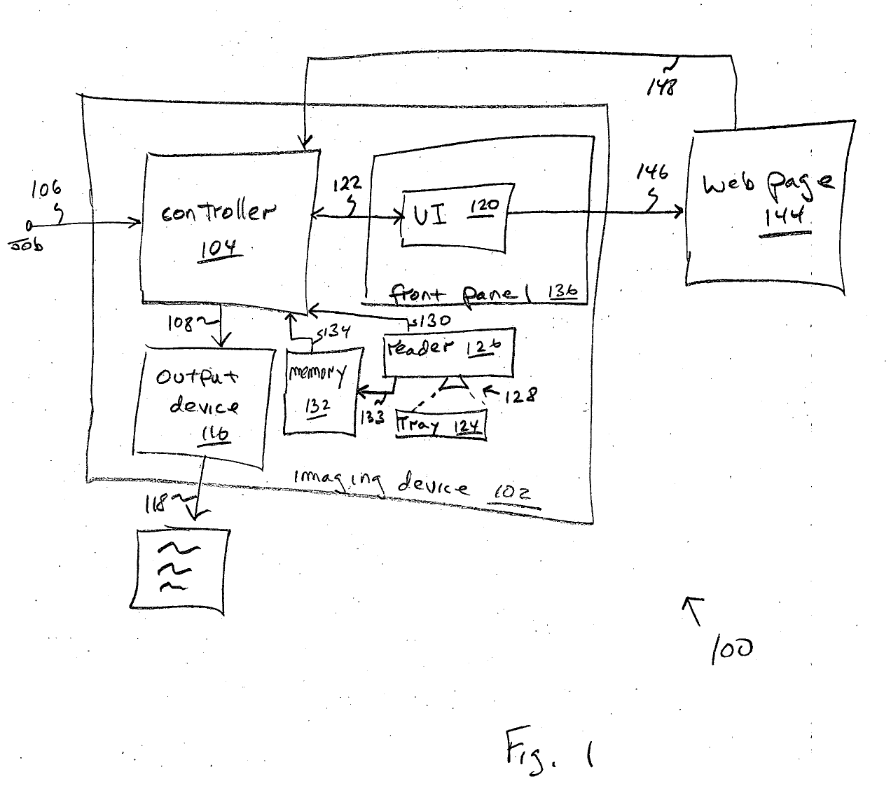

FIG. 1 is a schematic block diagram of the present invention imaging device system for adaptively controlling print options. The system 100 comprises an imaging device 102 with a controller 104. The controller 104 has an interface on line 106 to accept an imaging job. The controller 104 determines imaging job characteristics. A controller 104 has an interface on line 108 to supply selected capabilities in response to matching determined job characteristics to system capabilities. An imaging device output unit 116 has an interface on line 108 to accept the selected capabilities. The output unit 116 has an interface on line 118 to supply a job output responsive to the selected capabilities. The imaging device 102 may be a printer, copier, fax, scanner, or multifunctional peripheral (MFP). However, the invention is not necessarily limited to merely this group of devices, especially if the invention is used in a system other than a printing system.

The controller 104 determines job characteristics such as optimal print media, ink chemistry, and image processing. The controller 104 determines capabilities such as available print media, available inks, available image processes, and imaging device hardware. The above examples of job characteristics and system capabilities assume that the output unit 116 supplies a paper output (line 118). However, the job could also be a scan job that supplies an electronic document as an output, in which case the system capabilities are more likely to concern issues of resolution, memory, supported protocols, and processing speed.

Some aspects of the system may further comprise a user interface (UI) 120 connected to the controller 104 on line 122. The controller 104 determines available print media in response to enacting a user interface dialog with a user. For example, the dialog may submit questions concerning the type(s) of paper loaded in the imaging device paper tray 124. In some aspects, the imaging device may have a set of trays, perhaps a different tray for each paper type. Alternately, the system 100 may further comprise a reader 126 having an interface, as represented by reference designator 128, for accepting print media and an interface on line 130 for supplying decoded print media identification to the controller 104. For example, the reader 126 may be able to interpret information that is encoded in the paper as it lies in tray 124. Then, the controller 104 determines available print media to response to accepting the decoded print media identification from the reader 126.

In another aspect of the system 100, a memory 132 is loaded with the stored identification of available print media. For example, the type of paper loaded into tray 124 may be saved in memory 132, via line 133. In some aspects, the results of a user dialog or the decoded reader results (or however the information was obtained) can be stored. The memory 132 has an interface on line 134 connected to the controller 104. The controller 104 determines available print media in response accessing the memory 132. In some aspects, as shown, the user interface 120 resides at a front panel 136 of the imaging device 102.

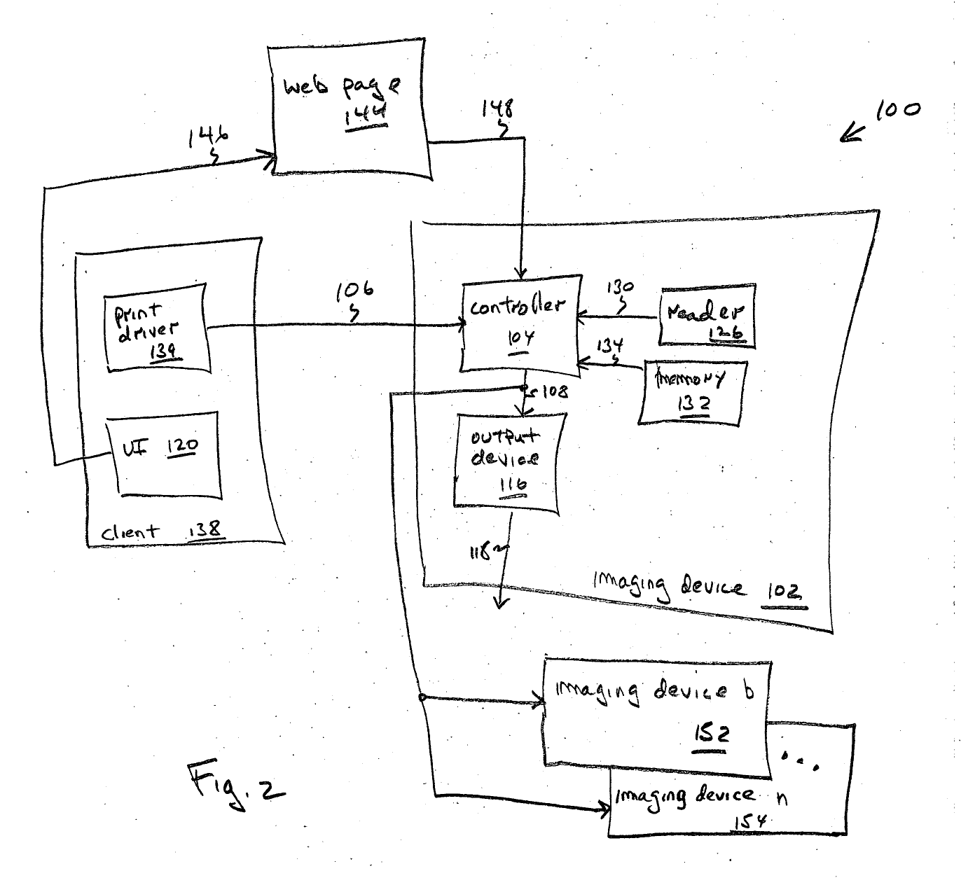

FIG. 2 is a schematic block diagram of the present invention imaging device system for adaptively controlling print options, with client-side features. As a variation to the system of FIG. 1, this aspect of the system 100 includes a client 138, such a personal computer, with a print driver 139, having an interface on line 106 for sending imaging jobs to the controller 104. The jobs may be electronic files that are sourced from an internal hard drive (not shown), for example. Line 106, to the imaging device 102, may represent a local connection, such as a USB, serial, or parallel port interface. Alternately, line 106 may represent a network connection, such as a local area network (LAN) interface. In a network-connected aspect of the system, a printer server (not shown) may act as an interface between the print driver 139 and the imaging device 102. Whether locally or network connected, in this aspect, the UI 120 resides with the client 138.

Viewing either FIG. 2 or FIG. 1, system 100 may include a web page (a web site) 144 having an interface on line 146 connected to the UI 120 and an interface on line 148 connected to the controller 104. Typically, lines 146 and 148 represent network connections.

One of the primary system capabilities concerns is the paper to be used. The controller 104 determines media characteristics such as media type, media weight, media brightness, tray number, media absorption, and media reflectivity. The controller 104 may also determine the media name, or other identifier, that will permit the controller 104 to indirectly determine media characteristics. For example, the memory 132 may include media characteristics cross-referenced to media names. In another aspect, the controller 104 determines the imaging device resolution capabilities. The resolution capabilities are dependent upon the firmware loaded in a particular imaging device.

In one aspect of the system 100 shown in FIG. 2, the controller 104 determines the file type of the job submitted on line 106, in response to examining the print driver print steam. For example, the characteristics associated with a text file, a Word.doc for example, are different from an image file, such as a Abode.pdf file.

In one aspect of the system 100 shown in FIG. 1, the UI 120 is connected to the controller on line 122, and controller 104 enacts a user interface dialog with the user to determine job characteristics. The UI 120 may reside on front panel 136 of the imaging device 102. Alternately, as shown in FIG. 2, the UI 120 may reside with the client 138. As another alternative (viewing either FIG. 1 or FIG. 2), the job characteristics and/or system capabilities information, such as the available print media, is sent to the controller 104 on line 148 from the web page 144, in response to a UI dialog. The UI 120 is connected to the web page 144 on line 146.

As shown in FIG. 2, some aspects of the system 100 may comprise a plurality of network-connected imaging devices interfaced to the controller 104. As shown, the controller 104 is also connected imaging device b (152) through n (154) on line 108, which in this case represents either a local or network connection. The controller 104 determines the capabilities of the plurality of network-connected imaging devices, matches the capabilities of the plurality of network-connected imaging devices to the job characteristics, and sends the job to the imaging device whose capabilities best match the job characteristics. Although not shown, the controller of FIG. 1 can also interface with a plurality of imaging devices, and choose the imaging device with the capabilities that best match the job.

With respect to both FIGS. 1 and 2, in some aspects of the system 100, the controller 104 automatically selects the imaging device capabilities in response to matching of system capabilities to job characteristics. In another aspect, the controller 104 establishes minimal match criteria and supplies a warning, via the UI 120, in response to detecting a match below the minimal match criteria. The controller 104 may present a user with an interface dialog for the selection of alternate imaging system capabilities, via the UI 120, in response to the warning.

In another aspect of the system 100, the controller 104 presents a user interface dialog for the selection of a means for determining the imaging system capabilities, via the UI 120. That is, the user may select whether the controller makes determinations based upon a UI dialog, a reader 126 identification of the media type, or through accessing stored capabilities in memory 132. If the user selects the UI dialog option, the controller 104 may present the findings of matching the system capabilities to job characteristics, via the UI 120, and supply a user interface dialog for the manual selection of imaging system capabilities. For example, the user may be queried, to select between a #20 brightness paper, at imaging device 102 for example, and a #24 brightness paper, at imaging device 152.

### Functional Description

As noted above, the imaging output device may be one or several of the following:
a printer—a device that receives and prints electronic data from a workstation. The data may be formatted on a workstation or in the printer prior to printing;
a copier—a device that optically scans an image and outputs the resulting image through the device's printing mechanism; or,
a MFP—a device that may combine the printing and copying characteristics described above in (1) and (2). Any device that produces a hardcopy paper output may be considered to be in one of these three general classes.

The output device may support color output as well as black-and-white output. In some aspects, the output device enters and stores information about the various available media. The output device is capable of transmitting this information to a host process, as appropriate. This mechanism consists of the following components:
a scanning device such as an optical scanner;
a control panel to control the operation of the mechanism;
a memory system to store data and parameters associated with the available media;
a processor that can process encoded media information (such as a bar code, detection of invisible inks that fluoresce under special lights, or similar commonly used identifiers), access the memory system to acquire and store data, and support a user dialog via the control panel to input and/or verify data associated with a particular media.

Several operations are involved in the overall process. These include:
media characterization, both manually inputted and automatically detected from the specially encoded media;
user-directed printing or copying; and,
optimization.

The manual media characterization operation is as follows:
1. The user indicates to the output device that data is to be entered for a particular media being used in the device. This operation may be, but is not limited to, pressing a particular button or series of buttons at the device front panel. Other manifestation may include interaction mechanisms such as an internal device web page or a series of control codes generated by a workstation.
2. The output device begins a dialog with the user by displaying a list of instructions, a menu of choices, a web page, or similar instances of user interaction.
3. If the output device is a printer, the output device asks the user a series of questions concerning the media. The user chooses a response from a series of options. For example, typical questions could be (but are not limited to) the following:

Type: (a) photo (b) copier (c) bond (d) colored (e) transparency (f) other;
Weight: (a)<20# (b) 20-24# (c) 24-28# (d) 28-40# (e) 40+#
Whiteness: (a) unknown (b)<90 (c) 90-92 (d) 92-95 (e) >95;
Drawer or Tray 1 2 3 4 5 (select all that apply);
What is the Media Name?: (optional user input via keypad or workstation).

The operation proceeds to step (6) below.
4. If the output device is a copier or MFP, the output device asks the user if the user wishes to enter media manually (as above (3)) or automatically using the device's scanner. If the user chooses manual entry, the output device proceeds as described in (3). If the user chooses automatic entry, the device prompts the user to place a sheet of the media on the scanner and indicate through a specific user interaction when the device may scan the media. Other questions may be asked at this point to determine if the media has some markings (such as bar codes) that may be used to characterize the media.
5. If the output device is a copier or MFP, the output device scans the media, searches for and identifies the media markings (such as a bar code), looks in the memory system to see if parameters for this media already exist, processes the media scan data to determine other parameters such as whiteness, displays to the user a list of the parameters, and offers the user the opportunity to change or update any parameters as desired. The user may also (optionally) generate a name for this particular media.
6. For all types of devices (printer, copier, and MFP), the output device may store the information in the memory system. This data characterizes the media and is now available to the user in the next stage of the printing process. Note, this data can be used to form a database of media information that may be accessed by subsequent users. Thus, media characterization need not be performed for every job that is submitted.

The User-Directed Printing or Copying Operation proceeds as follows:
1. If the user is printing to the printer or MFP, the user submits the job in the normal workflow (for example, using a Windows or Macintosh “Print” command within an application). At this point, one of four possibilities exist:
   (a) The printer or MFP may have no capability to determine the file or image type.
   (b) The printer or MFP firmware may have the ability to automatically determine the type of file or image being directed to the output device. For example, a file may contain an image or a bitmap. Or the file may consist of text. By examining the print stream, the output device may determine the type of image or file.
   (c) The printer or MFP may have the interactive ability to ask the user about the file or image type. This may be similar to an application known as a “status monitor”.
   (d) The printer or MFP firmware may receive information about the type of file or image through user the device driver or similar means.
2. If the user is copying to the copier or MFP, the user places the job on the scanner and presses the appropriate copy function. At this point, one of three possibilities exist:
   (a) The copier or MFP may have no capability to determine the file or image type.
   (b) The copier or MFP firmware may have the ability to automatically determine the type of file or image being directed to the output device. For example, a file may contain an image or a bitmap. Or the file may consist of text. By examining the copy stream, the output device may determine the type of image or file.
   (c) The copier or MFP may have the interactive ability to ask the user about the file or image type at the front panel. This may be accomplished at any time in the scanning process, although it would be typically performed first.
3. In the case of (1a) and (2a), the device simply prints or copies the job as directed, regardless of any media information that may be available.
4. In the case of (1b) and (2b), the device determines the type of image or file that is being processed. Next, it accesses the media database in the memory system to determine if the chosen media is likely to provide acceptable image quality. For example, it is doubtful that the best image quality for a photograph would be achieved using bond or recycled paper. Also, it is very costly to output text data on photographic paper. The system alerts the user to the likelihood of any potential problems or the system may make the appropriate choice of media (user's option).
5. In the case of (1c) and (2c), the device interactively asks the user for information on the image type. For scanning and copying, the user would typically indicate the image type at the device control panel immediately prior to submitting the copy job.

For printing, the user may be interrogated after the print job has been submitted. This mechanism would be similar to an application known in the industry as a “status monitor.” One manifestation of a status monitor may be seen in Sharp's Status Monitor (SMON). SMON relies on a thin client mechanism for two-way communications between device and workstation. Typical uses of SMON include notification of printing errors (i.e., “paper out”, “paper jam”, “toner out”, etc).

The Optimization operation proceeds as follows:
1. Based on information received in the User-Directed Printing and Copying Operation (above), the device processes the scan or print data, choosing the best available media for the image type. If the available media is not optimal for the type of image (for example, only photographic media is available and the job is a text document), the device outputs the file regardless of the media.
2. In addition, the output device may also perform media-specific image quality corrections. For example, high-quality media will support higher output resolutions than low-quality media such as recycled paper. Based on the media characterization, the device may choose to print the image differently on different media

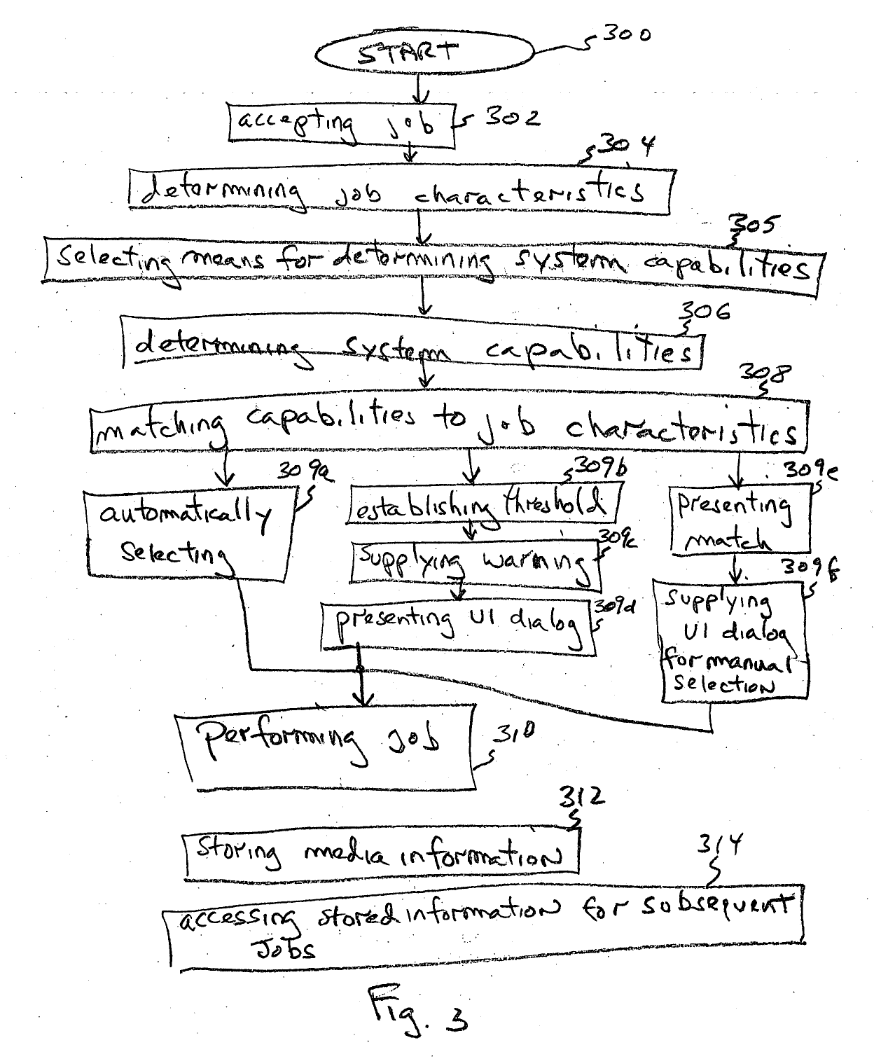

FIG. 3 is a flowchart illustrating the present invention method for adaptively controlling print options in a print system. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 300.

Step 302 accepts an imaging Job. For example, an electronic file or a hardcopy (paper) job can be accepted. Step 304 determines the imaging job characteristics. Step 306 determines an imaging system's capabilities. Step 308 matches system capabilities to job characteristics. Step 310 performs the job on an imaging device. The imaging device can be a printer, copier, fax, scanner, or MFP for example. It may perform a job such as printing or scanning, providing either a hardcopy or electronic file.

Determining the imaging job characteristics in Step 304 may includes determining job characteristics such as optimal print media, ink chemistry, and image processing. Determining an imaging system's capabilities in Step 306 may includes determining available print media, available inks, available image processes, and imaging device firmware.

In some aspects, determining available print media (Step 306) includes an action such as enacting a user interface dialog with a user, reading print media identification of paper loaded in an imaging device, or accessing a memory of stored media data. If a user interface dialog is enacted, then the dialog may be accessed from a node such as an imaging device front panel, a web page associated with an imaging device, or a client connected to an imaging device. When determining available print media (Step 306), media characteristics such as media type, media weight, media brightness, tray number, absorption, transparency, reflectivity, and media name can be considered. In other aspects, determining available image processes (Step 306) includes determining an imaging device's resolution capabilities.

Some aspects of the method include further steps. Step 312 stores the available print media information (or other system capability information). Then, Step 314 determines the available print media (or other capabilities) for subsequent imaging jobs in response to accessing the stored print media information.

In some aspects of the method, determining the imaging job characteristics in Step 302 includes determining the imaging job characteristics in response to an action such as examining the print driver print stream to determine the file type, enacting a user interface dialog with the user, receiving pre-determined imaging job characteristics from a device driver embedded in a PRN image file, or receiving pre-determined imaging job characteristics from a device driver embedded in a job stream. Again, if a user interface dialog is enacted, the dialog may be accessed from a node such as an imaging device front panel, a web page associated with an imaging device, or a client connected to an imaging device.

In other aspects, determining an imaging system's capabilities in Step 306 includes determining the capabilities of a plurality of network-connected imaging devices. Then, matching imaging system capabilities to job characteristics (Step 308) includes matching the capabilities of the plurality of network-connected imaging devices to the job characteristics. Step 310 performs the job of the imaging device whose capabilities best match the job characteristics.

Some aspects of the method include further steps. Step 309a automatically selects the imaging device capabilities in response to matching of system capabilities to job characteristics. Then, Step 310 performs the job in response to the automatic selection of imaging system capabilities.

In other aspects, Step 309b establishes minimal match criteria. Step 309c, following the matching of system capabilities to job characteristics, supplies a warning in response to detecting a match below the minimal match criteria. In some aspects, Step 309d presents a user with a user interface dialog for the selection of alternate imaging system capabilities in response to the warning.

In another aspect, Step 309e, in response to matching of imaging system capabilities to job characteristics, presents the match findings on a user interface to a user. Step 309f supplies a user interface dialog for the manual selection of imaging system capabilities. Then, Step 310 performs the job in response to the manual selection of imaging system capabilities.

In one aspect of the method a further step, Step 305, presents a user with a user interface dialog for the selection of a means for determining the imaging system capabilities, such as enacting a UI dialog, using a reader to decoded information embedded in the media, or accessing media data in memory. Then, Step 306 determines capabilities in response to the selection means dialog.

A system and method have been presented for adaptively controlling print options, to maximize print system capabilities. Examples of some system operations have been given, but the invention is not necessarily limited to just these examples. The invention has been presented in the context of a print system, however, it has broader application. Other variations and embodiments of the invention will occur to those skilled in the art.

1. In a print system, a method for adaptively controlling print options, the method comprising:
accepting an imaging job;
determining the imaging job characteristics;
determining an imaging system's capabilities;
matching system capabilities to job characteristics; and,
performing the job on an imaging device.

2. The method of claim 1 wherein determining the imaging job characteristics includes determining job characteristics selected from the group including optimal print media, ink chemistry, and image processing.

3. The method of claim 1 wherein determining an imaging system's capabilities includes determining available print media, available inks, available image processes, and imaging device firmware.

4. The method of claim 3 wherein determining available print media includes an action selected from the group including enacting a user interface dialog with a user, reading print media identification of paper loaded in an imaging device, and accessing a memory of stored media data.

5. The method of claim 4 wherein enacting a user interface dialog includes accessing the dialog from a node selected from the group including an imaging device front panel, a web page associated with an imaging device, and a client connected to an imaging device.

6. The method of claim 4 wherein determining available print media includes determining media characteristics selected from the group including media type, media weight, media brightness, tray number, and media name.

7. The method of claim 3 wherein determining available image processes includes determining an imaging device's resolution capabilities.

8. The method of claim 3 further comprising:
storing the available print media information; and,
determining the available print media for subsequent imaging jobs in response to accessing the stored print media information.

9. The method of claim 2 wherein determining the imaging job characteristics includes determining the imaging job characteristics in response to an action selected from the group including examining a print driver print stream to determine the file type, enacting a user interface dialog with the user, receiving pre-determined imaging job characteristics from a device driver embedded in a PRN image file, and receiving pre-determined imaging job characteristics from a device driver embedded in a job stream.

10. The method of claim 9 wherein enacting a user interface dialog with a user includes accessing the dialog from a node selected from the group including an imaging device front panel, a web page associated with an imaging device, and a client connected to an imaging device.

11. The method of claim 3 wherein determining an imaging system's capabilities includes determining the capabilities of a plurality of network-connected imaging devices;
wherein matching imaging system capabilities to job characteristics includes matching the capabilities of plurality of network-connected imaging devices to the job characteristics; and,
wherein performing the job on an imaging device includes performing the job of the imaging device whose capabilities best match the job characteristics.

12. The method of claim 1 wherein performing the job on an imaging device includes performing the job on an imaging device selected from the group including a printer, copier, fax, scanner, and multifunctional peripheral (MFP).

13. The method of claim 1 further comprising:
automatically selecting the imaging device capabilities in response to matching of system capabilities to job characteristics; and,
wherein performing the job on an imaging device includes performing the job in response to the automatic selection of imaging system capabilities.

14. The method of claim 1 further comprising:
establishing minimal match criteria; and,
following the matching of system capabilities to job characteristics, supplying a warning in response to detecting a match below the minimal match criteria.

15. The method of claim 14 further comprising:
presenting a user with a user interface dialog for the selection of alternate imaging system capabilities in response to the warning.

16. The method of claim 4 further comprising:
presenting a user with a user interface dialog for the selection of a means for determining the imaging system capabilities; and,
wherein determining an imaging system's capabilities includes determining capabilities in response to the selection means dialog.

17. The method of claim 1 further comprising:
in response to matching of imaging system capabilities to job characteristics, presenting the match findings on a user interface to a user;
supplying a user interface dialog for the manual selection of imaging system capabilities; and,
wherein performing the job on an imaging device includes performing the job in response to the manual selection of imaging system capabilities.

18. The method of claim 1 wherein accepting an imaging job includes accepting an imaging job selected from the group including an electronic file and a hardcopy.

19. The method of claim 1 wherein performing the job on an imaging device includes performing a job selected from the group including printing and scanning.

20. An imaging device system for adaptively controlling print options, the system comprising:
a controller having an interface to accept an imaging job, the controller determining imaging job characteristics and supplying selected capabilities at an interface in response to matching determined job characteristics to system capabilities; and
an output unit having an interface to accept the selected capabilities and to supply a job output responsive to the selected capabilities.

21. The system of claim 20 where the controller determines job characteristics selected from the group including optimal print media, ink chemistry, and image processing.

22. The system of claim 20 wherein the controller determines capabilities selected from the group including available print media, available inks, available image processes, and imaging device hardware.

23. The system of claim 22 further comprising:
a user interface (UI) connected to the controller; and,
wherein the controller determines available print media in response to enacting a user interface dialog with a user.

24. The system of claim 22 further comprising:
a reader having an interface for accepting print media and for supplying decoded print media identification to the controller; and,
wherein the controller determines available print media to response to accepting the decoded print media identification from the reader.

25. The system of claim 22 further comprising:
a memory, including the stored identification of available print media, having an interface connected to the controller; and,
wherein the controller determines available print media in response accessing the memory.

26. The system of claim 23 wherein the user interface resides at a front panel of the imaging device.

27. The system of claim 23 further comprising:
a client, with a print driver, having an interface for sending imaging jobs to the print driver; and,
wherein the UI resides with the client.

28. The system of claim 23 further comprising:
a web page having an interface connected to controller, for sending available print media information in response to a UI dialog; and,
wherein the UI has a connection to the web page.

29. The system of claim 22 wherein the controller determines media characteristics selected from the group including media type, media weight, media brightness, tray number, and media name.

30. The system of claim 22 wherein the controller determines the imaging device resolution capabilities.

31. The system of claim 27 wherein the controller determines the file type in response to examining the print driver print stream from the client.

32. The system of claim 21 further comprising:
a user interface connected to controller; and,
wherein the controller enacts a user interface dialog with the user to determine job characteristics.

33. The system of claim 32 wherein the user interface resides at a front panel of the imaging device.

34. The system of claim 32 further comprising:
a client, with a print driver, having an interface for sending imaging jobs to the controller; and,
wherein the UI resides with the client.

35. The system of claim 32 further comprising:
a web page having an interface connected to controller for sending job characteristics information in response to a UI dialog; and,
wherein the UI has a connection to the web page.

36. The system of claim 22 further comprising:
a plurality of network-connected imaging devices interfaced to the controller; and,
wherein the controller determines the capabilities of the plurality of network-connected imaging devices, matches the capabilities of the plurality of network-connected imaging devices to the job characteristics, and sends the job to the imaging device whose capabilities best match the job characteristics.

37. The system of claim 20 wherein the imaging device is an imaging device selected from the group including a printer, copier, fax, scanner, or multifunctional peripheral (MFP).

38. The system of claim 20 wherein the controller automatically selects the imaging device capabilities in response to the matching of system capabilities to job characteristics.

39. The system of claim 38 further comprising:
a user interface (UI) connected to the controller; and,
wherein the controller establishes minimal match criteria and supplies a warning, via the UI, in response to detecting a match below the minimal match criteria.

40. The system of claim 39 wherein the controller presents a user with an interface dialog for the selection of alternate imaging system capabilities, via the UI, in response to the warning.

41. The system of claim 22 further comprising:
a user interface (UI) having an interface to the controller; and,
wherein the controller presents a user interface dialog for the selection of a means for determining the imaging system capabilities, via the UI.

42. The system of claim 20 further comprising:
a user interface (UI) having an interface to the controller; and,
wherein the controller presents the findings of matching the system capabilities to job characteristics, via the UI, and supplies a user interface dialog for the manual selection of imaging system capabilities.
